(19) United States
(12) Patent Application Publication
(10) Pub. No.: US 2010/0269076 A1
(43) Pub. Date: Oct. 21, 2010

(54) TEST PATTERN GENERATION APPARATUS, TEST PATTERN GENERATION METHOD, AND MEDIUM STORING TEST PATTERN GENERATION PROGRAM

(75) Inventor: Fumiyuki Yamane, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/696,280

(22) Filed: Jan. 29, 2010

(30) Foreign Application Priority Data
Apr. 20, 2009 (JP) 2009-102085

(51) Int. Cl. G06F 17/50

(52) U.S. Cl. 716/4

(57) ABSTRACT

A test pattern generation apparatus includes an activation rate setting unit configured to set an activation rate of a cell, a test pattern generator configured to generate a test pattern based on the activation rate set by the activation rate setting unit, a supply voltage calculator configured to calculate a supply voltage of a semiconductor integrated circuit using the test pattern generated by the test pattern generator, and an output unit configured to output the test pattern generated by the test pattern generator when the supply voltage calculated by the supply voltage calculator fulfills the target supply voltage.

### CROSS-REFERENCE TO RELATED APPLICATION

This application is based upon and claims the benefit of priority from the prior Japanese Patent Application No. 2009-102085, filed on Apr. 20, 2009; the entire contents of which are incorporated herein by reference.

### BACKGROUND OF THE INVENTION

1. Field of the Invention

The present invention relates to a test pattern generation apparatus, a test pattern generation method, and a medium storing a test pattern generation program, particularly to a test pattern generation apparatus, a test pattern generation method, and a medium storing a test pattern generation program that are used to put a supply voltage of a semiconductor integrated circuit into a desired distribution.

2. Related Art

A conventional test pattern generation apparatus used to design the semiconductor integrated circuit generates a test pattern from a netlist including cell connection information, calculates a voltage drop (IR-Drop) using the generated test pattern, and determines a point at which the voltage drop becomes a predetermined reference value or more as a dangerous point (for example, see JP-A No. 2008-224315 (Kokai)). The cell at the dangerous point is dealt with as a defective product.

However, in the conventional test pattern generation apparatus, pieces of information except for the netlist are not used to generate the test pattern. That is, the test pattern is not generated in consideration of power consumption of the cell or the supply voltage distribution of the semiconductor integrated circuit. Therefore, when the test pattern generated by the conventional test pattern generation apparatus is used, it is necessary to make a test on the assumption that the semiconductor integrated circuit behaves at stricter timing than the semiconductor integrated circuit behaving in an actual usage environment. That is, in the test stage, it is necessary to fill in a gap between the test pattern and the actual usage environment.

As a result, there is generated a problem of overkill, in which a semiconductor integrated circuit passed in the actual usage environment (good product) is determined as a failed semiconductor integrated circuit (defective product) when the test is made using the test pattern. The overkill causes a yield of the semiconductor integrated circuit to be lowered.

On the other hand, when the test is made in order to improve the yield on the assumption that the semiconductor integrated circuit behaves at the timing close to the actual usage environment, it is necessary that an excessive margin be set to make design such that no problem with the behavior of the semiconductor integrated circuit is generated. That is, in the design stage, it is necessary to fill in the gap between the test pattern and the actual usage environment.

As a result, there are generated problems such as an increased chip area of the semiconductor integrated circuit, the increased power consumption, and a prolonged design time period.

### BRIEF SUMMARY OF THE INVENTION

According to a first aspect of the present invention, there is provided a test pattern generation apparatus comprising:

an activation rate setting unit configured to set an activation rate of a cell;

a test pattern generator configured to generate a test pattern based on the activation rate set by the activation rate setting unit;

a supply voltage calculator configured to calculate a supply voltage of a semiconductor integrated circuit using the test pattern generated by the test pattern generator; and

an output unit configured to output the test pattern generated by the test pattern generator when the supply voltage calculated by the supply voltage calculator fulfills the target supply voltage.

According to a second aspect of the present invention, there is provided a test pattern generation method comprising:

setting an activation rate of a cell;

generating a test pattern based on the activation rate;

calculating a supply voltage of a semiconductor integrated circuit using the test pattern; and

outputting the test pattern when the supply voltage calculated by the supply voltage calculator fulfills the target supply voltage.

According to a third aspect of the present invention, there is provided a medium storing a program to make a computer execute a test pattern generation method comprising:

setting an activation rate of a cell;

generating a test pattern based on the activation rate;

calculating a supply voltage of a semiconductor integrated circuit using the test pattern; and

outputting the test pattern when the supply voltage calculated by the supply voltage calculator fulfills the target supply voltage.

### BRIEF DESCRIPTION OF THE DRAWINGS

FIG. 1 is a block diagram illustrating a configuration of a test pattern generation apparatus 10 according to the first embodiment of the present invention.

FIG. 2 is a block diagram illustrating functions that are realized when a processor 14 of FIG. 1 activates a test pattern generation program 16a.

FIG. 3 is a flowchart illustrating a procedure of the test pattern generation operation according to the first embodiment of the present invention.

FIG. 4 is a flowchart illustrating a procedure of an activation rate setting operation (S303) of FIG. 3.

FIG. 5 is a flowchart illustrating a procedure of an activation rate reconfiguring operation (S311) of FIG. 3.

FIG. 6 is a block diagram illustrating functions in the test pattern generation apparatus 10 according to the second embodiment of the present invention that are realized when the processor 14 activates the test pattern generation program 16a.

FIG. 7 is a flowchart illustrating a procedure of the test pattern generation operation according to the second embodiment of the present invention.

### DETAILED DESCRIPTION OF THE INVENTION

Hereafter, embodiments of the present invention will be described more specifically with reference to the drawings.

### First Embodiment

A first embodiment of the invention will be described. The first embodiment is an example of a test pattern generation apparatus that outputs a test pattern. The test pattern is generated such that the supply voltage distribution of the semiconductor integrated circuit fulfills a target supply voltage.

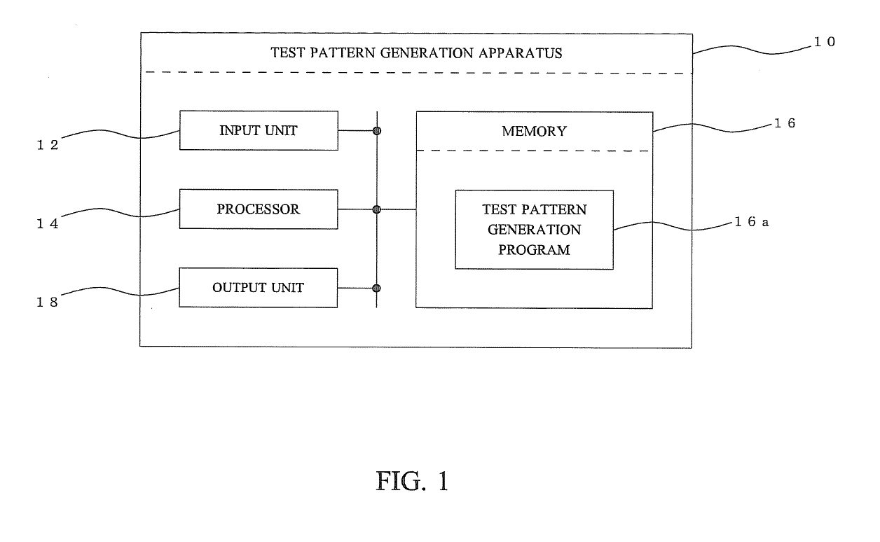

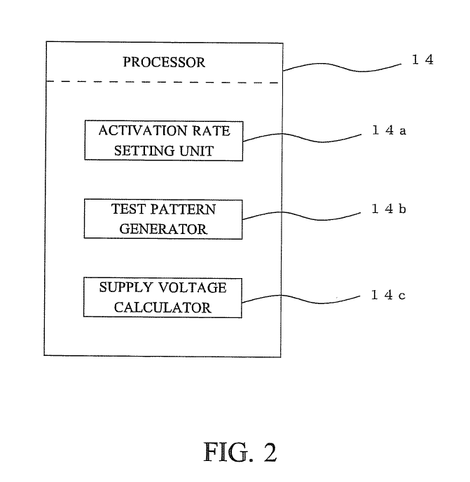

A configuration of a test pattern generation apparatus according to the first embodiment of the present invention will be described below. FIG. 1 is a block diagram illustrating a configuration of a test pattern generation apparatus 10 according to the first embodiment of the present invention. FIG. 2 is a block diagram illustrating functions that are realized when a processor 14 of FIG. 1 activates a test pattern generation program 16a.

As illustrated in FIG. 1, the test pattern generation apparatus 10 according to the first embodiment of the present invention includes an input unit 12, a processor 14, a memory 16, and an output unit 18.

The input unit 12 of FIG. 1 is an interface that receives input of predetermined information from the outside of the test pattern generation apparatus 10. For example, the input unit 12 is connected to an input device such as a keyboard, a network, or the like.

The processor 14 of FIG. 1 activates the test pattern generation program 16a stored in the memory 16 to perform the test pattern generation operation.

Various kinds of data including the test pattern generation program 16a can be stored in the memory 16 of FIG. 1. The test pattern generation program 16a includes a command for realizing a predetermined function. Various kinds of information including information received by the input unit 12 and information generated by the processor 14 can be stored in the memory 16.

The output unit 18 of FIG. 1 is an interface that outputs predetermined information to the outside of the test pattern generation apparatus 10. For example, the output unit 18 is connected to a display, a network, a database, or the like.

As illustrated in FIG. 2, when the processor 14 activates the test pattern generation program 16a, an activation rate setting unit 14a, a test pattern generator 14b, and a supply voltage calculator 14c are realized.

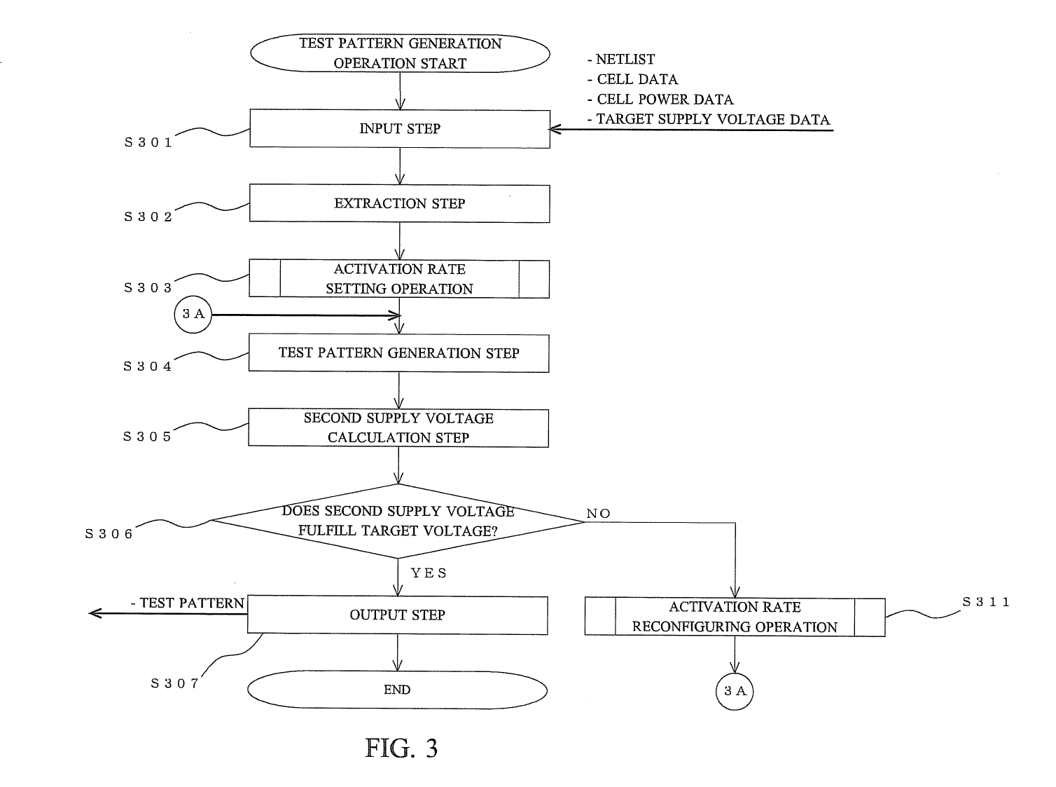

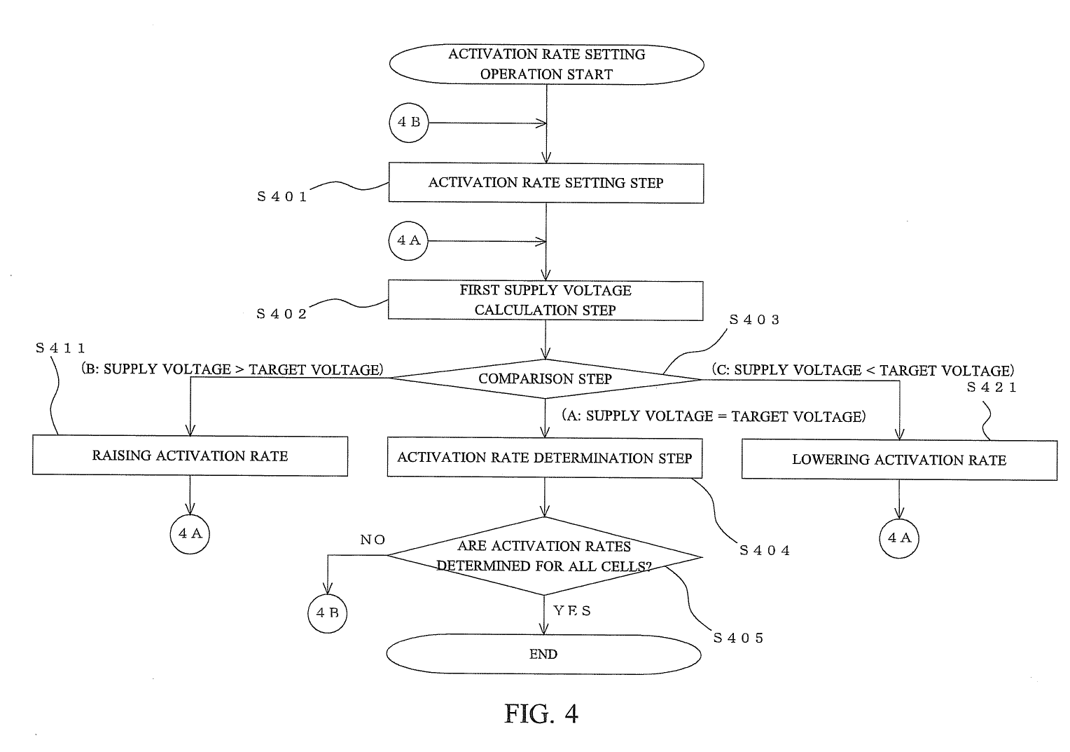

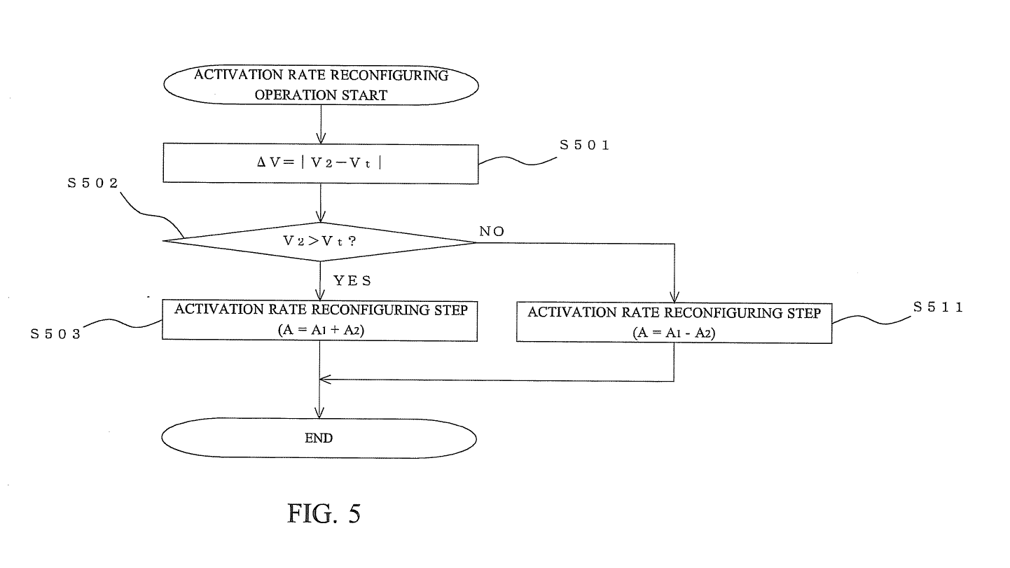

A behavior of the test pattern generation apparatus 10 according to the first embodiment of the present invention will be described. FIG. 3 is a flowchart illustrating a procedure of the test pattern generation operation according to the first embodiment of the present invention. FIG. 4 is a flowchart illustrating a procedure of an activation rate setting operation (S303) of FIG. 3. FIG. 5 is a flowchart illustrating a procedure of an activation rate reconfiguring operation (S311) of FIG. 3.

A test pattern generation operation according to the first embodiment of the present invention will be described with reference to FIG. 3. The test pattern generation operation according to the first embodiment of the present invention is performed to the whole of the semiconductor integrated circuit.

(FIG. 3: INPUT STEP (S301)) The input unit 12 receives inputs of the netlist, cell data, cell power data, and target supply voltage data from the outside of the test pattern generation apparatus 10. The netlist includes connection information on a plurality of cells (primitive cell) in the semiconductor integrated circuit. The cell data includes positional information (coordinate on a layout of the semiconductor integrated circuit) on the cell and interconnection information on supply interconnection connected to the cell. The cell power data includes power consumption of the cell in the semiconductor integrated circuit. The target supply voltage data expresses a target value (hereinafter referred to as “target supply voltage (Vₜ)”) of the supply voltage in each region on the layout of the semiconductor integrated circuit, and the target supply voltage data includes positional information (coordinate on the layout of the semiconductor integrated circuit) and the target supply voltage (Vₜ). Users make the netlist, the cell data, the cell power data, and the target supply voltage data by an arbitrary method before the test pattern generation operation. As a result, the information necessary for the test pattern generation operation is fed to the processor 14.

(FIG. 3: EXTRACTION STEP (S302)) The activation rate setting unit 14a extracts an object cell of the test pattern generation operation and supply interconnection connected to the object cell using the netlist and the cell data. As a result, the object cell in which the activation rate is set and the supply interconnection connected to the object cell are determined.

(FIG. 3: ACTIVATION RATE SETTING OPERATION (S303)) The activation rate setting operation (S303) is performed to determine the activation rate of the object cell.

The activation rate setting operation (S303) will be described with reference to FIG. 4. The activation rate setting operation (S303) is performed in each cell in the semiconductor integrated circuit. The activation rate setting operation (S303) is performed on the assumption that cells (hereinafter referred to as “non-object cells”) except for the object cell do not behave (that is, current derived from the non-object cell is not passed through the supply interconnection connected to the object cell).

(FIG. 4: ACTIVATION RATE SETTING STEP (S401)) The activation rate setting unit 14a sets a predetermined value (for example, 50%) as an initial value of the activation rate (A) of the object cell.

(FIG. 4: FIRST SUPPLY VOLTAGE CALCULATION STEP (S402)) Using the cell power data, the activation rate setting unit 14a calculates a consumption current (that is, consumption current of the object cell when the non-object cells do not behave) of the object cell based on the activation rate (A). Then, the activation rate setting unit 14a calculates a voltage drop (that is, a voltage drop of the object cell when the non-object cells do not behave) of the object cell when the consumption current is passed through the supply interconnection. Then, the activation rate setting unit 14a calculates a supply voltage (hereinafter referred to as “first supply voltage (V₁)”) of the object cell based on the voltage drop. As a result, the supply voltage of the object cell when the non-object cells do not behave is determined.

(FIG. 4: COMPARISON STEP (S403)) The activation rate setting unit 14a compares the first supply voltage (V₁) with a target supply voltage (Vₜ). When the first supply voltage (V₁) fulfills the target supply voltage (Vₜ) (A in S403), the procedure advances to an activation rate determination step (S404). For example, when the first supply voltage (V₁) is matched with the target supply voltage (Vₜ), the first supply voltage (V₁) fulfills the target supply voltage (Vₜ). When the first supply voltage (V₁) does not fulfill the target supply voltage (Vₜ) (B in S403 or C in S403), the procedure advances to a step (S411 or S421) of reconfiguring the activation rate (A). For example, the procedure advances to a step (S411) of raising the activation rate (A) when the first supply voltage (V₁) is larger than the target supply voltage (Vₜ) (B in S403), and the procedure advances to a step (S421) of lowering the activation rate (A) when the first supply voltage (V₁) is smaller than the target supply voltage (Vₜ) (C in S404).

(FIG. 4: ACTIVATION RATE DETERMINATION STEP (S404)) The activation rate setting unit 14a sends the activation rate (A) of the object cell to the test pattern generator 14b. As a result, the activation rate (A) of the object cell for generating the test pattern is fed to the test pattern generator 14b.

(FIG. 4: S405) The activation rate setting operation ends when the activation rates are determined for all the cells (that is, when the activation rate determination step (S404) is performed to all the cells (YES in S405). The procedure returns to the activation rate setting step (S401) when the cell whose activation rate is not determined (that is, the cell to which the activation rate determination step (S404) is not performed) exists (NO in S405).

(FIG. 4: S411) The activation rate setting unit 14a raises the activation rate (A) of the object cell. As a result, the activation rate (A) of the object cell is reconfigured such that the first supply voltage (V₁) fulfills the target supply voltage (Vₜ). The procedure returns to the first supply voltage calculation step (S402) after the step in S411.

(FIG. 4: S421) The activation rate setting unit 14a lowers the activation rate (A) of the object cell. As a result, the activation rate (A) of the object cell is reconfigured such that the first supply voltage (V₁) fulfills the target supply voltage (Vₜ). The procedure returns to the first supply voltage calculation step (S402) after the step in S421.

The test pattern generation operation according to the first embodiment of the present invention will be described again with reference to FIG. 3.

(FIG. 3: TEST PATTERN GENERATION STEP (S304)) The test pattern generator 14b generates the test pattern based on the activation rate (A) sent from the activation rate setting unit 14a in the activation rate determination step (S404). As a result, the test pattern for the semiconductor integrated circuit is determined.

(FIG. 3: SECOND SUPPLY VOLTAGE CALCULATION STEP (S305)) The supply voltage calculator 14c calculates consumption currents of all the cells in the semiconductor integrated circuit using the cell power data and the test pattern. Then, the supply voltage calculator 14c calculates the voltage drops of all the cells when the consumption currents are passed through the supply interconnection. Then, the supply voltage calculator 14c calculates supply voltages (hereinafter referred to as “second supply voltages (V₂)”) of all the cells based on the voltage drop. As a result, a supply voltage distribution of the semiconductor integrated circuit is determined.

(FIG. 3: S306) The supply voltage calculator 14c compares the second supply voltage (V₂) of each cell with the target supply voltage (Vₜ) of each cell. The procedure advances to an output step (S307) when the second supply voltages (V₂) fulfill the target supply voltages (Vₜ) for all the cells (YES in S306). For example, when the second supply voltages (V₂) for all the cells are matched with the target supply voltages (Vₜ), the second supply voltages (V₂) fulfill the target supply voltages (Vₜ). The procedure advances to the activation rate reconfiguring step (S311) when the second supply voltage (V₂) does not fulfill the target supply voltage (Vₜ) (NO in S306).

(FIG. 3: ACTIVATION RATE RECONFIGURING OPERATION (S311)) The activation rate reconfiguring operation (S311) is performed to the cell in which the second supply voltage (V₂) does not fulfill the target supply voltage (Vₜ).

The activation rate reconfiguring operation (S311) will be described with reference to FIG. 5. The activation rate reconfiguring operation (S311) is performed to each cell in the semiconductor integrated circuit.

(FIG. 5: S501) The activation rate setting unit 14a calculates an absolute value (ΔV) of a difference between the second supply voltage (V₂) and the target supply voltage (Vₜ) using the target supply voltage data.

(FIG. 5: YES in S502, ACTIVATION RATE RECONFIGURING STEP (S503)) When the second supply voltage (V₂) is larger than the target voltage (Vₜ) (YES in S502)), the activation rate setting unit 14a reconfigures the activation rate (A) by adding a predetermined activation rate (A₂) to a set activation rate (A₁). The activation rate (A₂) corresponds to the absolute value (ΔV) of an amount of supply voltage change of the object cell or the cell in the group when the predetermined activation rate is fed. For example, the activation rate setting unit 14a reconfigures the activation rate (A) using a table expressing a relationship between the absolute value (ΔV) and the activation rate (A₂). As a result, the activation rate (A) is reconfigured such that the second supply voltage (V₂) fulfills the target voltage (Vₜ). The activation rate reconfiguring operation (S311) ends after an activation rate reconfiguring step (S503). The procedure returns to the test pattern generation step (S304) after the activation rate reconfiguring operation (S311).

(FIG. 5: NO in S502, ACTIVATION RATE RECONFIGURING STEP (S511)) When the second supply voltage (V₂) is smaller than the target voltage (Vₜ) (NO in S502), the activation rate setting unit 14a reconfigures the activation rate (A) by subtracting the activation rate (A₂) from the set activation rate (A₁). As a result, the activation rate (A) is reconfigured such that the second supply voltage (V₂) fulfills the target voltage (Vₜ). The activation rate reconfiguring operation (S311) ends after an activation rate reconfiguring step (S511). The procedure returns to the test pattern generation step (S304) after the activation rate reconfiguring operation (S311).

The test pattern generation operation according to the first embodiment of the present invention will be described again with reference to FIG. 3.

(FIG. 3: OUTPUT STEP (S307)) The output unit 18 outputs the test pattern generated in the test pattern generation step (S304). As a result, the users can recognize the test pattern that is generated such that the second supply voltage (V₂) fulfills the target supply voltage (Vₜ). The test pattern generation operation according to the first embodiment of the present invention ends after the output step (S307).

Alternatively, in the first embodiment of the present invention, the target supply voltage data may include four coordinates indicating the region on the layout of the semiconductor integrated circuit and the target supply voltage (Vₜ) of each region.

Alternatively, in the first embodiment of the present invention, the target supply voltage (Vₜ) may range in a predetermined range (for example, 0.8 [V] to 1.0 [V]). In this case, in S501, the activation rate setting unit 14a calculates an absolute value (ΔV) of a difference between the second supply voltage (V₂) and an intermediate value (for example, 0.9 [V]) of the target supply voltage.

According to the first embodiment of the present invention, the test pattern output in the output step (S307) is generated based on the activation rate (A) that is calculated such that the second supply voltage (V₂) fulfills the target supply voltage (Vₜ). That is, the gap between the test pattern and the actual usage environment is eliminated when the target supply voltage (Vₜ) is determined on the assumption that the semiconductor integrated circuit behaves at the strictest timing in the actual usage environment. When the test is made using the test pattern, only the semiconductor integrated circuit that becomes failed in the actual usage environment is determined as the failed semiconductor integrated circuit. That is, the semiconductor integrated circuit that becomes passed in the actual usage environment is not determined as the failed semiconductor integrated circuit. Therefore, the overkill can be reduced to improve the yield. Therefore, the premise of the excessive margin is not necessary for the design of the semiconductor device. Therefore, the chip area, the power consumption, and the design time period can be improved.

Furthermore, according to the first embodiment of the present invention, when the second supply voltage (V₂) does not fulfill the target supply voltage (Vₜ), the activation rate reconfiguring operation (S311) is performed based on the difference between the second supply voltage (V₂) and the target supply voltage (Vₜ). Therefore, in the test pattern generation step (S304) after the activation rate reconfiguring operation (S311), the test pattern is generated based on the reconfigured activation rate. As a result, the number of steps of the test pattern generation operation is decreased, so that the operation time can be shortened.

Furthermore, according to the first embodiment of the present invention, when the target supply voltage (Vₜ) exists within the predetermined range, there is a higher probability that the second supply voltage (V₂) fulfills the target supply voltage (Vₜ). As a result, the number of steps of the test pattern generation operation is further decreased, so that the operation time can be further shortened.

### Second Embodiment

A second embodiment of the invention of the present invention will be described. The second embodiment of the present invention is an example of a test pattern generation apparatus that performs the test pattern generation operation in each group including the plural cells assigned under the predetermined condition.

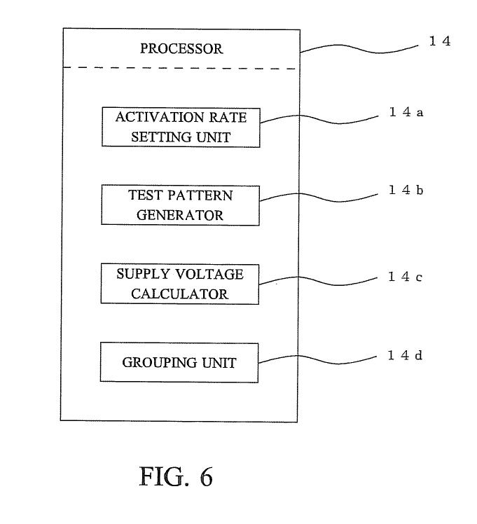

A configuration of a test pattern generation apparatus according to the second embodiment of the present invention will be described. FIG. 6 is a block diagram illustrating functions in the test pattern generation apparatus 10 according to the second embodiment of the present invention that are realized when the processor 14 activates the test pattern generation program 16a.

As illustrated in FIG. 6, when the processor 14 activates the test pattern generation program 16a, the activation rate setting unit 14a, the test pattern generator 14b, the supply voltage calculator 14c, and a grouping unit 14d are realized. The activation rate setting unit 14a, the test pattern generator 14b, and the supply voltage calculator 14c are same as those in the test pattern generation apparatus 10 according to the first embodiment of the present invention.

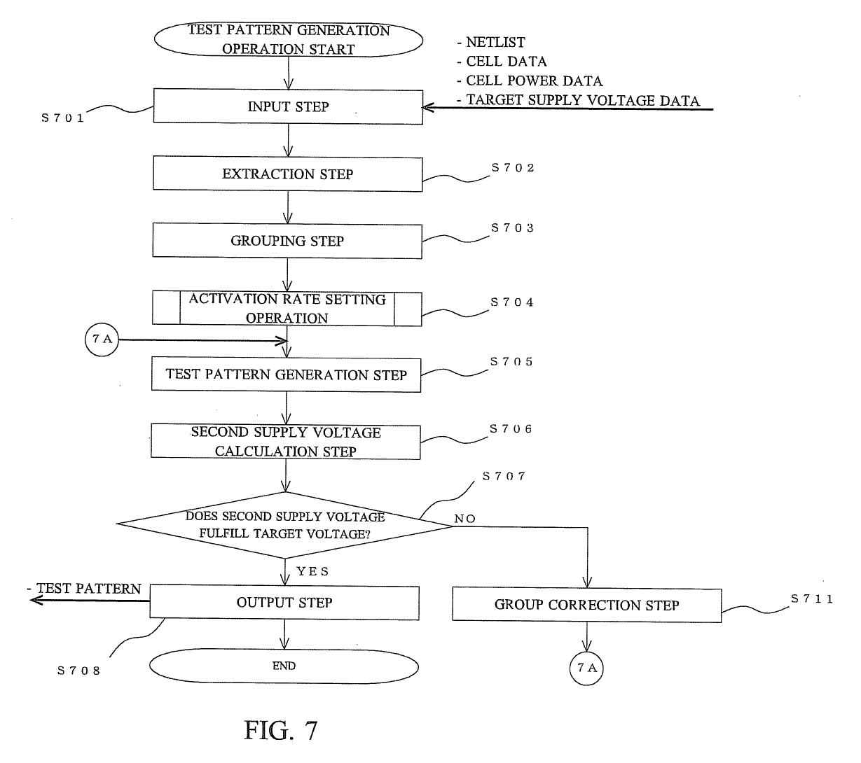

A behavior of the test pattern generation apparatus 10 according to the second embodiment of the present invention will be described. FIG. 7 is a flowchart illustrating a procedure of the test pattern generation operation according to the second embodiment of the present invention.

(FIG. 7: INPUT STEP (S701) and EXTRACTION STEP (S702)) An input step (S701) and an extraction step (S702) are similar to the input step (S301) and extraction step (S302) of FIG. 3.

(FIG. 7: GROUPING STEP (S703)) The grouping unit 14d assigns the plural cells in the regions having the common target supply voltage (Vₜ) to generate the group referring to the netlist, the cell data, and the target supply voltage data. As a result, the groups corresponding to each region having the common target supply voltages (Vₜ) are generated.

(FIG. 7: ACTIVATION RATE SETTING OPERATION (S704)) An activation rate setting operation (S704) is similar to the activation rate setting operation (S303) of FIG. 3. However, in the second embodiment of the present invention, the activation rate setting operation (S704) is performed in each group.

(FIG. 7: TEST PATTERN GENERATION STEP (S705) to OUTPUT STEP (S708)) A test pattern generation step (S705) to an output step (S708) are similar to the test pattern generation step (S304) to the output step (S307) of FIG. 3. The test pattern generation operation according to the second embodiment of the present invention ends after the output step (S708).

(FIG. 7: GROUP CORRECTION STEP (S711)) The grouping unit 14d corrects the group when the second supply voltage (V₂) does not fulfill the target supply voltage (Vₜ) (NO in S707). For example, the grouping unit 14d assigns part of the cells assigned to the group to an adjacent group (that is, a group having a different target supply voltage (Vₜ)) to the group. The procedure returns to the test pattern generation step (S705) after the group correction step (S711).

Alternatively, in the second embodiment of the present invention, when the second supply voltage (V₂) does not fulfill the target supply voltage (Vₜ) (NO in S707), the group correction step (S711) may be performed after the activation rate reconfiguring operation (S311) of FIG. 3 is performed predetermined times.

According to the second embodiment of the present invention, the test pattern generation operation is performed in each group. Therefore, the operation time can be shortened.

Furthermore, according to the second embodiment of the present invention, the group correction step (S711) is performed when the second supply voltage (V₂) does not fulfill the target supply voltage (Vₜ) (NO in S707). Therefore, it is not necessary to reconfigure the activation rate. As a result, the number of steps of the test pattern generation operation can be decreased to shorten the operation time.

At least a portion of the test pattern generation apparatus 10 according to the above-described embodiments of the present invention may be composed of hardware or software. When at least a portion of the test pattern generation apparatus 10 is composed of software, a program for executing at least some functions of the test pattern generation apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the test pattern generation apparatus 10 according to the above-described embodiment of the present invention may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

The above-described embodiments of the present invention are just illustrative, but the invention is not limited thereto. The technical scope of the invention is defined by the appended claims, and various changes and modifications of the invention can be made within the scope and meaning equivalent to the claims.

What is claimed is:

1. A test pattern generation apparatus comprising:
an activation rate setting unit configured to set an activation rate of a cell;
a test pattern generator configured to generate a test pattern based on the activation rate set by the activation rate setting unit;
a supply voltage calculator configured to calculate a supply voltage of a semiconductor integrated circuit using the test pattern generated by the test pattern generator; and
an output unit configured to output the test pattern generated by the test pattern generator when the supply voltage calculated by the supply voltage calculator fulfills the target supply voltage.

2. The apparatus of claim 1, wherein the activation rate setting unit reconfigures the activation rate of the cell when the supply voltage does not fulfill the target supply voltage.

3. The apparatus of claim 2, wherein the activation rate setting unit adds the activation rate corresponding to an absolute value of a difference between the supply voltage and a target supply voltage to an already-set activation rate or subtracts the activation rate corresponding to the absolute value of the difference between the supply voltage and the target supply voltage from the already-set activation rate.

4. The apparatus of claim 1, further comprising a grouping unit configured to produce a group by assigning a plurality of cells in regions having the common target supply voltage,
wherein the activation rate setting unit sets the activation rate in each group produced by the grouping unit.

5. The apparatus of claim 2, further comprising a grouping unit configured to produce a group by assigning a plurality of cells in regions having the common target supply voltage,
wherein the activation rate setting unit sets the activation rate in each group produced by the grouping unit.

6. The apparatus of claim 3, further comprising a grouping unit configured to produce a group by assigning a plurality of cells in regions having the common target supply voltage,
wherein the activation rate setting unit sets the activation rate in each group produced by the grouping unit.

7. The apparatus of claim 4, wherein the grouping unit corrects the group when the supply voltage does not fulfill the target supply voltage.

8. The apparatus of claim 5, wherein the grouping unit corrects the group when the supply voltage does not fulfill the target supply voltage.

9. The apparatus of claim 6, wherein the grouping unit corrects the group when the supply voltage does not fulfill the target supply voltage.

10. A test pattern generation method comprising:
setting an activation rate of a cell;
generating a test pattern based on the activation rate;
calculating a supply voltage of a semiconductor integrated circuit using the test pattern; and
outputting the test pattern when the supply voltage calculated by the supply voltage calculator fulfills the target supply voltage.

11. The method of claim 10, wherein in setting the activation rate, the activation, rate of the cell is reconfigured when the supply voltage does not fulfill the target supply voltage.

12. The method of claim 11, wherein in setting the activation rate, the activation rate corresponding to an absolute value of a difference between the supply voltage and a target supply voltage is added to an already-set activation rate or the activation rate corresponding to the absolute value of the difference between the supply voltage and the target supply voltage is subtracted from the already-set activation rate.

13. The method of claim 10, further comprising producing a group by assigning a plurality of cells in regions having the common target supply voltage,
wherein in setting the activation rate, the activation rate in each group is set.

14. The method of claim 11, further comprising producing a group by assigning a plurality of cells in regions having the common target supply voltage,
wherein in setting the activation rate, the activation rate in each group is set.

15. The method of claim 12, further comprising producing a group by assigning a plurality of cells in regions having the common target supply voltage,
wherein in setting the activation rate, the activation rate in each group is set.

16. The method of claim 13, wherein in producing the group, the group is corrected when the supply voltage does not fulfill the target supply voltage.

17. The method of claim 14, wherein in producing the group, the group is corrected when the supply voltage does not fulfill the target supply voltage.

18. The method of claim 15, wherein in producing the group, the group is corrected when the supply voltage does not fulfill the target supply voltage.

19. A medium storing a program to make a computer execute a test pattern generation method comprising:
setting an activation rate of a cell;
generating a test pattern based on the activation rate;
calculating a supply voltage of a semiconductor integrated circuit using the test pattern; and
outputting the test pattern when the supply voltage calculated by the supply voltage calculator fulfills the target supply voltage.

20. The medium of claim 19, wherein in setting the activation rate, the activation rate of the cell is reconfigured when the supply voltage does not fulfill the target supply voltage.
